(19) United States
(12) Patent Application Publication
(10) Pub. No.: US 2015/0206679 A1
(43) Pub. Date: Jul. 23, 2015

(54) VOLTAGE CONTROLLER FOR AN ELECTRIC FAN

(71) Applicant: Johnson Electric S.A., Murten (CH)

(72) Inventors: Marco BUSSA, Asti (IT); Massimiliano MIGLIARELLI, Asti (IT)

(21) Appl. No.: 14/604,276

(22) Filed: Jan. 23, 2015

(30) Foreign Application Priority Data
Jan. 23, 2014 (IT) TO2014U000011

(51) Int. Cl. H01H 37/32; F04D 25/06; F04D 19/00; H01H 37/04

(52) U.S. Cl. CPC H01H 37/32; H01H 37/04; F04D 25/06; F04D 19/002

(57) ABSTRACT

A voltage controller has an casing, with a plurality of electrical connecting terminals, and housing a signal processing circuit and a power circuit, facing one another and connected to these terminals. A thermally fusible safety device is fitted between the circuits, and is electrically connected between one of the terminals and the power circuit. The safety device has a strip of resiliently deformable and electrically conductive material and a plate-like positioning and support formation. The formation has a seat which forms an opening through which a first end of the strip is connected to the power circuit. A second end of the strip is connected to one of the terminals by a thermally fusible connection. The strip is coupled to the formation with a pre-loading arranged to break the connection of its second end.

### CROSS REFERENCE TO RELATED APPLICATIONS

This non-provisional patent application claims priority under 35 U.S.C. §119(a) from Utility Model Application No. TO 2014 U 000011 filed in Italy on Jan. 23, 2014, the entire contents of which are hereby incorporated by reference.

### FIELD OF THE INVENTION

The present invention relates to a voltage controller for an electric fan, particularly for a heat exchanger (such as a radiator) of a motor vehicle.

### BACKGROUND OF THE INVENTION

More specifically, the invention proposes a voltage controller of the type comprising a support casing of electrically insulating material, at one end of which there is provided a plurality of electrical connecting terminals, and in which there are fitted a signal processing circuit and a power circuit, substantially facing one another and connected to said terminals.

Such voltage controllers control the operating speed of the fan but are subject to overloading and thus overheating which may lead to catastrophic failure of the controller and is a fire risk.

### SUMMARY OF THE INVENTION

Hence there is a desire for an improved voltage controller which will not overheat and thus does not pose a fire risk.

Accordingly, in one aspect thereof, the present invention provides a voltage controller for an electric cooling fan, comprising: a support casing of electrically insulating material, at one end of which there is provided a plurality of electrical connecting terminals, and in which there are fitted a signal processing circuit and a power circuit, substantially facing one another and connected to said terminals; and a thermally fusible safety device fitted between said circuits, and electrically connected between one of the electrical terminals and the power circuit, the thermally fusible device comprising: a strip of resiliently deformable and electrically conductive material; and a plate-like positioning and support formation, integral with the casing and having a seat which forms an opening through which a first end of the strip is connected mechanically and electrically in a permanent way to the power circuit; a second end of the strip being connected mechanically and electrically to one of the terminals by means of a thermally fusible connection; the strip being coupled to the positioning and support formation in such a way as to be resiliently pre-loaded, with a pre-loading which tends to break the connection of its said second end.

Preferably, the first end of the conductive strip is connected to the power circuit by means of a soldered electrical joint.

Preferably, the thermally fusible connection of the second end of the conductive strip is made by soldering with a thermally fusible added material.

Preferably, the terminal to which the second end of the conductive strip is connected has a recess for receiving the solder material.

Preferably, the second end of the conductive strip has a through opening for receiving the solder material.

Preferably, the thermally fusible added material is a tin-based alloy.

Preferably, the strip has two lateral branches extending from an intermediate portion having an essentially V-shaped configuration, which bears on the positioning and support formation.

According to a second aspect, the present invention provides an electric cooling fan for a heat exchanger of a motor vehicle, incorporating the above voltage controller.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a partially exploded perspective view of a voltage controller according to the present invention;

FIG. 2 is a partial, perspective view of the voltage controller of FIG. 1;

FIG. 3 is an enlarged scale view of a detail indicated by III in FIG. 2; and

FIG. 4 is a perspective view showing part of the voltage controller device according to the preceding figures.

### DETAILED DESCRIPTION OF THE PREFERRED EMBODIMENTS

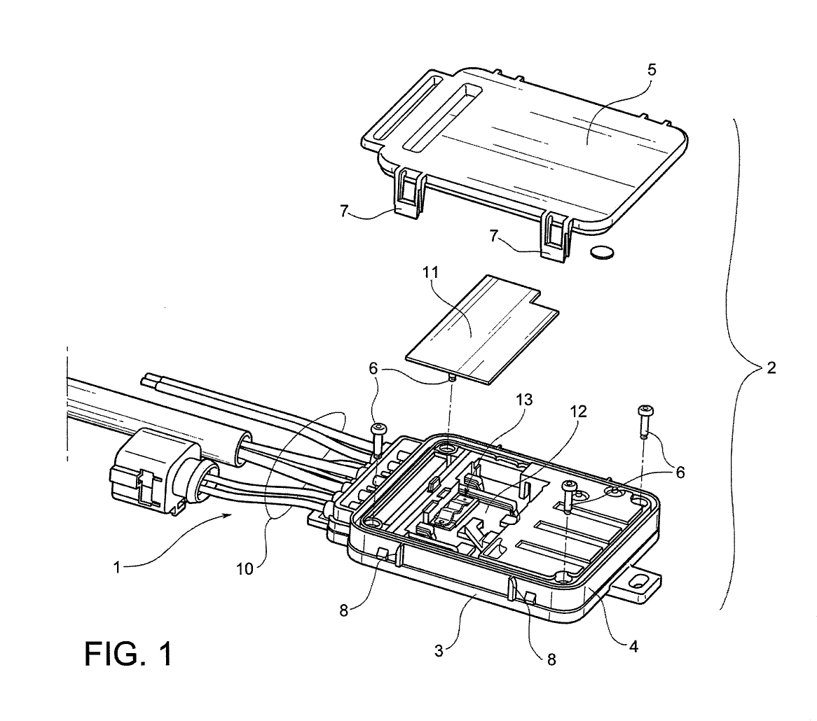

In the drawings, the number 1 indicates the whole of a voltage controller for an electric fan, particularly as used in a cooling fan module for a heat exchanger of a motor vehicle, made according to the present invention. This voltage controller 1 comprises a support casing, indicated as a whole by 2 in FIG. 1.

In the embodiment illustrated, the support casing 2 comprises a lower cover 3, an intermediate frame 4 and an upper cover 5. The intermediate frame 4 is connected to the lower cover by means of screws 6. The upper cover 5 is connected to the intermediate frame 4 by means of a plurality of peripheral attachment formations 7, coupled to corresponding projecting retaining formations 8 of the intermediate frame 4.

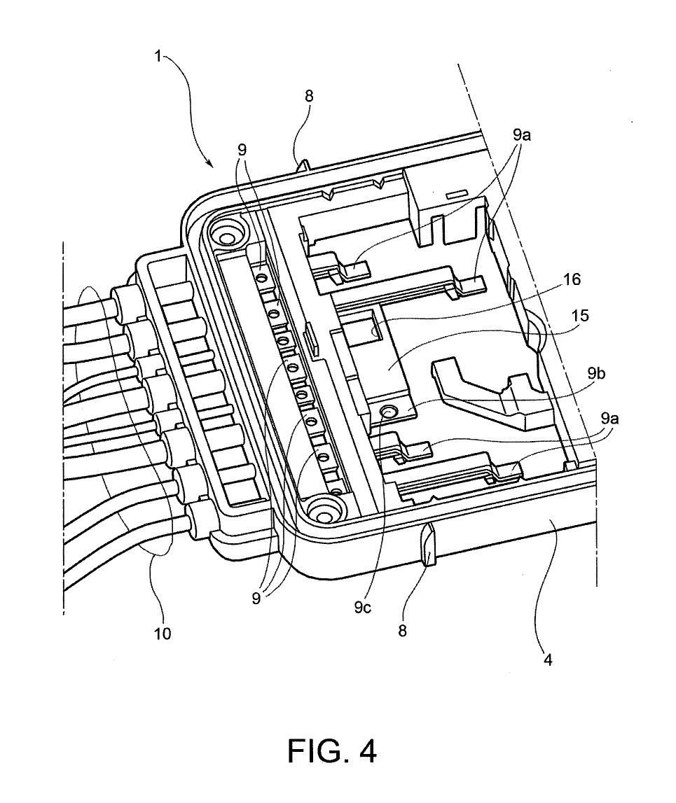

In the illustrated embodiment, the intermediate frame 4 has a plurality of electrical terminals at one end, indicated by 9 in FIG. 4. These terminals may be formed by cutting and bending from a single planar element of metallic material, particularly a copper-based alloy. These terminals are partially embedded in the intermediate frame 4, after a respective insulated electrical connecting conductor has been attached to each of them, optionally by soldering. In FIGS. 1, 2 and 4, these connecting conductors are cumulatively indicated by 10.

A signal processing circuit, whose components are carried on a circuit board indicated by 11 in FIG. 1, and a power circuit, whose components are carried on a further circuit board indicated by 12 in FIGS. 1 to 3, are housed inside the support casing 2. The circuit boards 11 and 12 substantially face one another and are connected to the terminals 9 in predetermined ways.

Inside the support casing 2, a thermally fusible safety device, indicated as a whole by 13 in FIGS. 1 to 3, is fitted between the circuit boards 11 and 12.

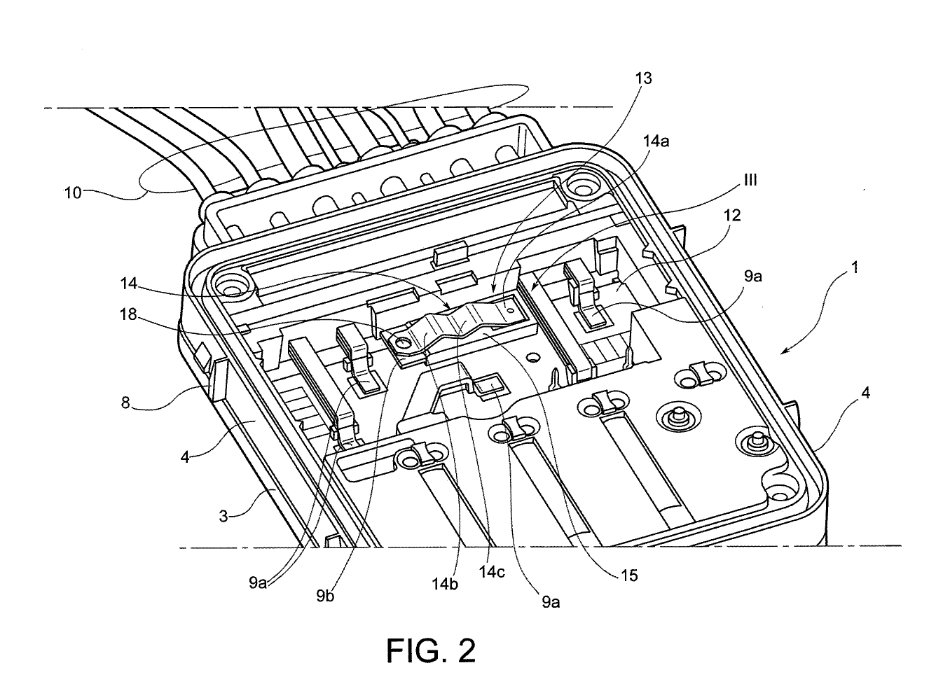

This thermally fusible device 13 is connected electrically between one of the aforesaid electrical terminals, particularly that indicated by 9b in FIGS. 2 to 4, and the power circuit carried by the circuit board 12.

In the illustrated embodiment, the thermally fusible device 13 comprises a strip 14 made of an elastically deformable and electrically conductive material, particularly a metallic material. The strip 14 is shaped and essentially has two opposed lateral branches 14a, 14b, extending from an intermediate portion 14c having an essentially V-shaped configuration.

The thermally fusible device 13 further comprises a plate-like positioning and support formation 15 (see, in particular, FIGS. 2 to 4), which is integral with, and preferably made in one piece with, the intermediate frame 4 of the support casing 2.

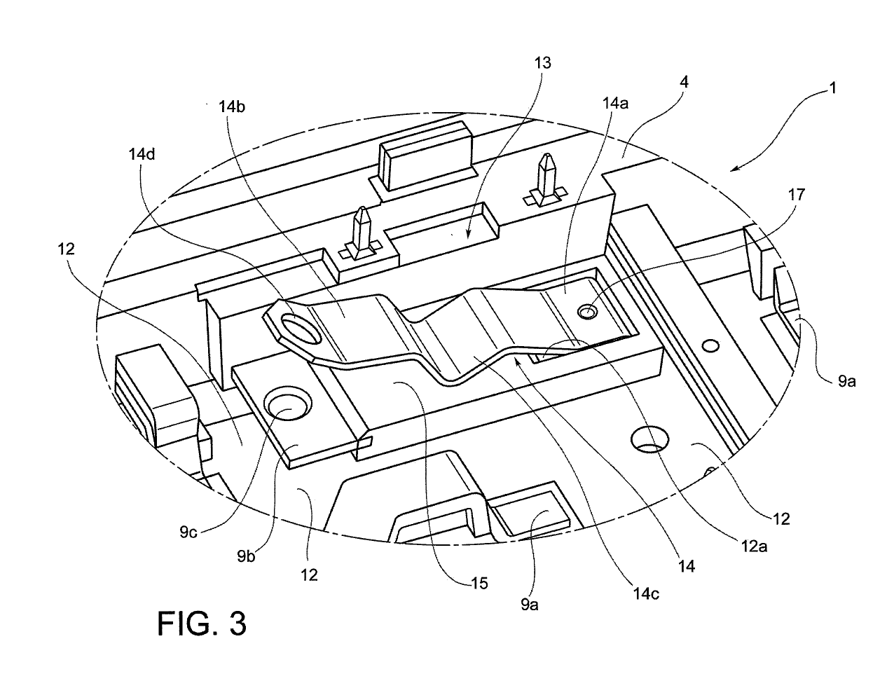

As shown more clearly in FIG. 4, the positioning and support formation 15 has a seat 16 which forms an opening through which the end 14a of the strip 14 is connected mechanically and electrically and in a permanent way to a terminal 12a (FIG. 3) of the power circuit carried by the board 12. The permanent connection between the end 14a of the strip 14 and the terminal 12a is conveniently formed by a soldered electrical joint, indicated by 17 in FIG. 3.

The other end 14b of the conductive strip 14 is connected mechanically and electrically to the terminal 9b (FIGS. 2 to 4) by means of a thermally fusible connection. This thermally fusible connection is conveniently made by soldering with an added material 18 (FIG. 2) such as a tin-based solder alloy.

In FIGS. 1 and 2, the conductive strip 14 is shown in the operating condition, in which its end 14b is connected by a thermally fusible connection to the terminal 9b.

On the other hand, FIG. 3 shows the strip 14 in the condition preceding the formation of this thermally fusible connection: the intermediate V-shaped portion 14c of the strip 14 bears on the positioning and support formation 15, and the end 14b of this strip is spaced apart from the terminal 9b.

In order to make the thermally fusible connection, the end branch 14b of the strip 14 is pressed against, and brought into contact with, the terminal 9b, so that the strip 14 is elastically pre-loaded, with a pre-loading that tends to break the connection between its end 14b and the terminal 9b.

Conveniently, as shown in FIGS. 3 and 4, a recess 9c is made in the terminal 9b, for receiving and containing the added solder material. Additionally, the end 14b of the strip 14 conveniently has a through opening 14d (FIG. 3), for receiving the added solder material.

In operation, if the temperature inside the casing 2 of the voltage controller 1 rises excessively and exceeds a predetermined threshold, the thermally fusible connection between the end 14b of the strip 14 and the terminal 9b is broken. In this condition, the elastic pre-loading with which the end branch 14b of the strip was connected to the terminal 9b ensures a safe “opening” of the connection, making it impossible for this connection to be restored, even momentarily.

The thermally fusible safety device 13 therefore enables the supply to the power circuit to be cut off, thus preventing damage to the circuit and avoiding, in particular, any risk of ignition and fire. Once broken, the thermally fusible connection can be restored only by specific intervention by an operator.

Naturally, provided that the principle of the invention is retained, the forms of application and the details of embodiment may be varied widely from what has been described and illustrated purely by way of example and without restrictive intent, the invention extending to all embodiments which achieve the same usefulness by using the same innovative principles.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. Voltage controller for an electric cooling fan, comprising:
a support casing of electrically insulating material, at one end of which there is provided a plurality of electrical connecting terminals, and in which there are fitted a signal processing circuit and a power circuit, substantially facing one another and connected to said terminals; and
a thermally fusible safety device fitted between said circuits, and electrically connected between one of the electrical terminals and the power circuit,
the thermally fusible device comprising:
a strip of resiliently deformable and electrically conductive material; and
a plate-like positioning and support formation, integral with the casing and having a seat which forms an opening through which a first end of the strip is connected mechanically and electrically in a permanent way to the power circuit;
a second end of the strip being connected mechanically and electrically to one of the terminals by means of a thermally fusible connection;
the strip being coupled to the positioning and support formation in such a way as to be resiliently pre-loaded, with a pre-loading which tends to break the connection of its said second end.

2. Voltage controller of claim 1, wherein the first end of the conductive strip is connected to the power circuit by means of a soldered electrical joint.

3. Voltage controller of claim 1, wherein the thermally fusible connection of the second end of the conductive strip is made by soldering with a thermally fusible added material.

4. Voltage controller of claim 3, wherein the terminal to which the second end of the conductive strip is connected has a recess for receiving the solder material.

5. Voltage controller of claim 3, wherein the second end of the conductive strip has a through opening for receiving the solder material.

6. Voltage controller of claim 3, wherein the thermally fusible added material is a tin-based alloy.

7. Voltage controller of claim 1, wherein the strip has two lateral branches extending from an intermediate portion having an essentially V-shaped configuration, which bears on the positioning and support formation.

8. An electric cooling fan for a heat exchanger of a motor vehicle, incorporating the voltage controller of claim 1.
